(19) United States
(12) Patent Application Publication
(10) Pub. No.: US 2009/0065094 A1
(43) Pub. Date: Mar. 12, 2009

(54) Shear linkage device

(75) Inventor: Ross T. Gault, JR., Olathe, KS (US)

Correspondence Address: Emma Harty, Esq.;BRYAN CAVE LLP, Suite 3600, 211 N. Broadway, St. Louis, MO, 63102-2750, US

(73) Assignee: Arrow Forklift Parts, LLC

(21) Appl. No.: 12/221,762

(22) Filed: Aug. 6, 2008

Related U.S. Application Data
(60) Provisional application No. 60/971,020, filed on Sep. 10, 2007.

(51) Int. Cl. A01G 23/08

(52) U.S. Cl. 144/34.5

(57) ABSTRACT

The invention is directed to a shear device. The shear device comprises two mounting plates that form a first cutting member that is pivotally coupled to a second cutting member to facilitate moving the shear device between open and closed positions. The shear device further includes an extension arm extending from the mounting plates and pivotally connected to a rocker linkage device. An actuator is coupled to the first cutting member. The actuator has a piston slideably engaged in a cylinder, which is coupled to the rocker linkage device. The rocker linkage device is configured to pivot about the extension arm as the piston extends from the cylinder and to transfer force from the piston to a secondary linkage bar. The secondary linkage bar is configured to further transfer force to the second cutting member.

### RELATED APPLICATIONS

This application claims priority to, and the benefits of U.S. Provisional Patent Application Ser. No. 60/971,020, filed Sep. 10, 2007, the contents of which are incorporated herein by reference in its entirety.

### FIELD OF THE INVENTION

The present invention relates to mechanical attachments for front-end loaders and other motorized vehicles. More particularly, the present invention relates to a shear device having gripping teeth disposed along a receiving jaw to grip the object being cut by a cutting edge of the shear.

### DESCRIPTION OF THE PRIOR ART

Prior to the embodiments outlined in this application, hydraulically activated tree shears have been used to forcefully shear trees for a number of years. However, one of the problems with the current geometry of the hydraulic linkages is that the cutting force decreases as the hydraulic actuator extends away from the cylinder. If the cutting force sufficiently decreases, various problems could arise. For example, the cutting blade may not exert sufficient force on the tree to shear the tree or the blade may become stuck in the tree. Another problem with conventional hydraulic tree shears is the geometry of the hydraulics. In some instances the hydraulic actuator is placed in a position that leaves it open and vulnerable to falling debris which may cause damage to the hydraulic.

Accordingly, a need exists for a hydraulically activated shear that overcomes one or more of the problems of conventional tree shears.

### SUMMARY OF THE INVENTION

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

The present invention includes embodiments directed to a shear device. The shear device comprises two mounting plates that form a first cutting member. The first cutting member is pivotally coupled to a second cutting member to facilitate moving the shear device between open and closed positions. In one embodiment, the second cutting member has a cutting edge formed at least partially along the lower side portion.

The shear device further includes an extension arm extending from the mounting plates and pivotally connected to a rocker linkage device. The rocker linkage device is coupled to a secondary linkage bar, and the secondary linkage bar is further coupled to the second cutting member. An actuator is coupled to the first cutting member. The actuator has a piston slideably engaged in a cylinder, which is coupled to the rocker linkage device. The actuator is configured to facilitate selectively moving the shear device between the open and closed positions as the piston extends outwardly from the cylinder.

The rocker linkage device is configured to pivot about the extension arm as the piston extends from the cylinder and to transfer force from the piston to the secondary linkage bar. The secondary linkage bar is configured to further transfer force to the second cutting member.

### BRIEF DESCRIPTION OF THE DRAWINGS

Non-limiting and non-exhaustive embodiments of the present invention are described with reference to the following figures, wherein like reference numerals refer to like parts throughout the various views unless otherwise specified.

FIG. 1 illustrates an embodiment of the shear device in accordance with the present invention;

FIG. 2 illustrates a rocker linkage device in accordance with the present invention;

FIG. 3 illustrates a top plan view of the shear device in accordance with the present invention;

FIG. 4 illustrates another top plan view of the shear device in accordance with the present invention;

FIG. 5 illustrates another top plan view of the shear device in accordance with the present invention;

FIG. 6 illustrates a side elevation view of the shear device in accordance with the present invention;

FIG. 7 illustrates another side elevation view of the shear device in accordance with the present invention;

FIG. 8 illustrates a position of a fastener in accordance with the present invention;

FIG. 9 illustrates a second cutting member in accordance with the present invention;

FIG. 10 illustrates a second cutting member in accordance with the present invention; and

FIG. 11 is a line graph depicting the cutting force of a shear device in accordance with the present invention.

### DETAILED DESCRIPTION

Embodiments are described more fully below with reference to the accompanying figures, which form a part hereof and show, by way of illustration, specific exemplary embodiments. These embodiments are disclosed in sufficient detail to enable those skilled in the art to practice the invention. However, the invention may be implemented in many different forms and should not be construed as being limited to the embodiments set forth herein. The following detailed description is, therefore, not to be taken in a limiting sense in that the scope of the present invention is defined only by the appended claims.

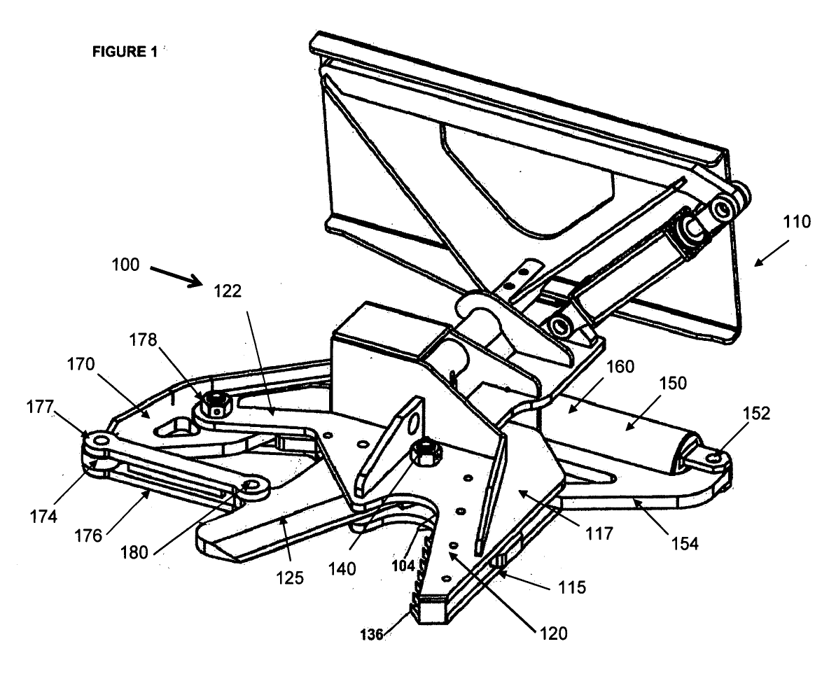

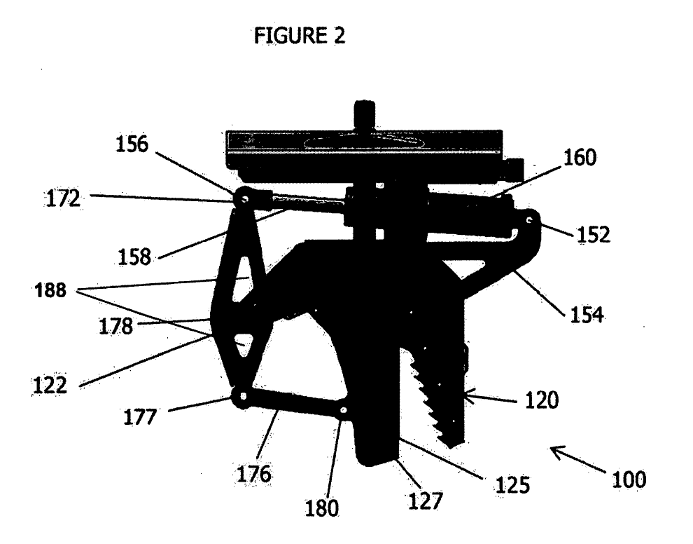

Referring now to FIGS. 1 and 2, a shear device 100 in accordance with the present invention is illustrated. Shear device 100 refers generally to a shear mechanism that is configured to facilitate a variety of tasks including the felling, sizing and pruning of timber, brush and other vegetation. However, it should also be apparent that other non-organic material, such as scrap metal, plastic and the like could be cut using shear device 100. Shear device 100 is configured to be adapted for use as an attachment for a plurality of vehicles, including, but not limited to, front-end loaders, skid loaders, tractors, backhoes, excavators and/or end loaders. However, the examples described herein should not be considered to be limiting, as the uses and applications of the present invention are limited only by the imagination of the user. For simplicity of description, shear device 100 of the present invention will be described as it could be used on skid loaders to fell or prune timber and brush.

Shear device 100 comprises a first mounting plate 115 and a second mounting plate 117. A first end of mounting plates 115, 117 comprises a generally angular first cutting member 120. Mounting plates 115, 117 further comprise an extension arm 122 at a second end. Extension arm 122 is configured to extend from the second end of mounting plates 115, 117 and to couple to a rocker linkage 170 at an extension arm pivot 178, described in more detail herein.

At a third end, mounting plates 115, 117 are positioned in a spaced relationship with one another to form a pocket 104 for at least partially receiving a cutting edge 125 of second cutting member 127. In one exemplary embodiment, pocket 104 is configured to extend from the upper edge portion of first cutting member 120 through a lower edge portion of first cutting member 120 so that debris may pass freely though first cutting member 120.

One or more fasteners 102 is coupled to mounting plates 115, 117 to minimize movement of plates 115, 117 away from one another during use of shear device 100. Fasteners 102 are transversely disposed through plates 115, 117 of first cutting member 120, and may be tightened and/or loosened to bring plates 115, 117 closer together and/or further apart. In one exemplary embodiment, a plurality of fasteners 102 are positioned along a long axis of first cutting member 120, as depicted in FIG. 1.

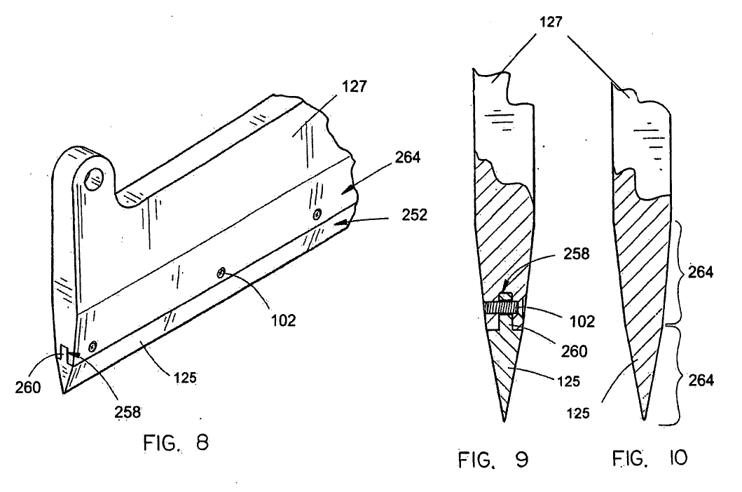

Fasteners 102 can be further understood with reference to an exemplary embodiment illustrated in FIG. 8. For example, one position of fastener 102 configured to permit cutting edge 125 to be partially received within pocket 104. Fasteners 102 can comprise any type of fastener known in the art, such as bolts and nuts. Fasteners 102 can also comprise a sleeve and/or similar element disposed around fasters 102 to protect fasteners from debris.

First cutting member 120 and second cutting member 127 are pivotally connected to each other at pivot point 140. Pivot point 140 comprises any type of pivoting joint known in the art, such as, for example, a high strength sleeve and shaft assembly coupled to the rearward end potions of first cutting member 120 and second cutting member 127.

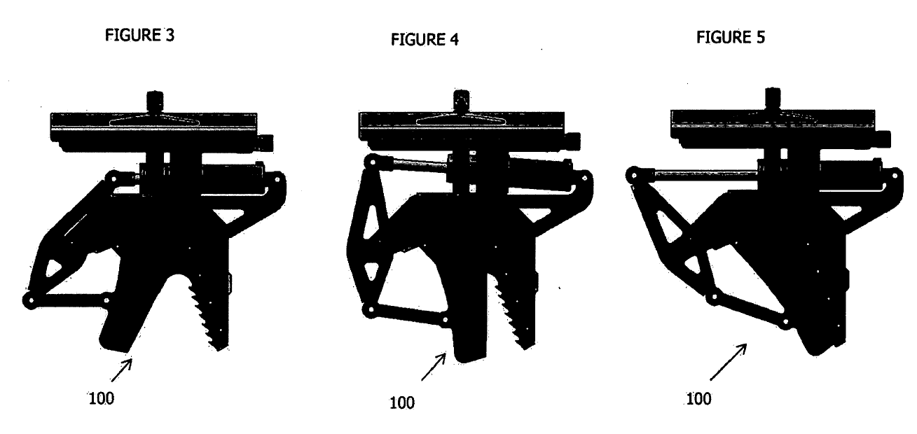

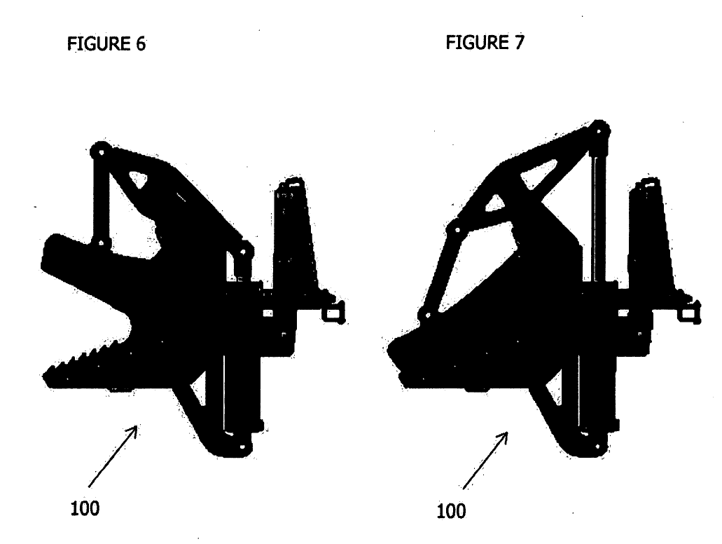

A side of cutting edge 125 is pivotally connected at a point 140 to mounting plates 115, 117. A hydraulic actuator 150 is used to facilitate control and movement of cutting edge 125. For example, hydraulic actuator 150 is configured to move first cutting member 120 and second cutting member 127 between open and closed positions with respect to one another. FIGS. 3 through 7 illustrate various stages of first cutting member 120 and second cutting member 127 moving from a fully open position (FIG. 3) to a partially closed position (FIG. 4) and then to a fully closed position (FIG. 5) in accordance with the present invention. FIGS. 6 and 7 also illustrated exemplary embodiments of cutting edge 125 of second cutting member 127 moving from various positions while tree shear 100 is rotated to operate in a vertical position. While FIGS. 3-7 illustrate some positions of first cutting member 120 and second cutting member 127, hydraulic actuator 150 can facilitate movement of first cutting member 120 and second cutting member 127 into any number and types of positions.

Hydraulic actuator 150 has two ends. A first end 152 is pivotally connected to the end of a stabilizing joint 154, while the other ends of joint 154 are mounted between mounting plates 115 and 117. The second end of actuator 150 is a distal end 156 of the piston 158 that moves within a cylinder 160. Distal end 156 is pivotally connected to the rocker linkage 170 designed to maximize the force of the hydraulic actuator 150 by delivering that force to cutting edge 125. This force in turn facilitates maximizing the cutting force of cutting edge 125 throughout the extension of piston 158.

Hydraulic actuator 150 is protected by a cylinder 160 configured to facilitate blocking and/or preventing debris from fully impacting hydraulic actuator 150. Cylinder 160 may be positioned to protect the top and/or bottom of hydraulic actuator 150. One or more brackets may be used to secure cylinder 160 to actuator 150. While a single hydraulic actuator 150 is illustrated, a plurality of actuators could be used to provide cutting force for shear 100.

In certain embodiments, first cutting member 120 may include one or more teeth 136 extending generally outwardly from an edge portion of first mounting plate 115 and/or second mounting plate 117. Teeth 136 are configured to be positioned with respect to the forward and rearward end portions of first cutting member 120 so that an object disposed between second cutting member 127 and first cutting member 120 will become at least partially engaged by teeth 136 as second cutting member 127 and first cutting member are moved towards the closed position. In one exemplary embodiment, a plurality of teeth 136 are disposed along the an edge portion of first mounting plate 115 and/or second mounting plate 117 to facilitate gripping by shear device 100 along a greater length of first cutting member 120.

Teeth 136 are configured to have one or more engagement points for at least partially piercing or deforming an object to be cut, such as, for example, a tree limb. In one exemplary embodiment, teeth 136 have a triangular shape. Teeth 136 are positioned generally outwardly from an edge of first jaw member 120 such that teeth 136 point toward pivot 140 (i.e., Jorgensen-Style Configuration) to facilitate the ability of teeth 136 to engage and secure an object between first cutting member 120 and second cutting member 127. In one exemplary embodiment, teeth 136 are integrally formed with an edge portion of first mounting plate 115 and/or second mounting plate 117. In another exemplary embodiment, teeth 136 are not integral with mounting plate 115 and/or second mounting plate 117, but are configured to couple to first mounting plate 115 and/or second mounting plate 117 using a fastener or other device for coupling components as known in the art.

As depicted in FIGS. 8, 9 and 10, cutting edge 125 of second cutting member 127 can be configured to be removably coupled with the lower side portion of second cutting member 127 to facilitate fast and easy repair or replacement of cutting edge 125. In one embodiment, cutting edge 125 is configured to be removable to facilitate replacement of cutting edge 125 and/or exchange of cutting edge 125 for another type of cutting edge for cutting a particular type of material. In one embodiment, one or more blade fasteners 102 may be used to removably secure cutting edge 125 to the lower side of second cutting member 127. In another embodiment, second cutting member 127 is configured with a channel 258 shaped to releasable receive a tongue 260 extending from a backside of cutting edge 125. While channel 258 and tongue 260 depicted in FIGS. 8 and 9 are relatively elongated and rectangular in shape, it is contemplated that they may be provided with nearly any interlocking shapes desired, such as a dovetail, to facilitate prevention of movement of cutting edge 125 in a transverse direction with respect to the edge portion of second cutting member 127. While they may be used separately, edge fasteners 102, channel 258 and tongue 260 may be used simultaneously to provide a strong, releasable engagement between cutting edge 125 and second cutting member 127.

Regardless of whether cutting edge 125 is removably or permanently coupled with second cutting member 127, cutting edge 125 may be configured in a variety of configurations. For example, cutting edge 125 may be shaped to have a plurality of bevels on one or both sides of cutting edge 125. As depicted in FIG. 10, a first bevel 262 may be formed to extend rearwardly from the tip of cutting edge 125. A second bevel 264 may be formed to extend rearwardly from first bevel 262. This design creates a more durable cutting edge as most single bevel designs will tend to roll the edge cutting edge over time. The second bevel is formed at an angle that is more acute that first bevel 262, which induces less friction along second bevel 264 as the cutting edge passes through the material being cut.

With reference again to exemplary embodiments illustrated in FIG. 1 and FIG. 2, shear device 100 further comprises a rocker linkage 170 to facilitate a cutting force within shear device 100 that increases as cutting edge 125 nears its closed position, i.e., as piston 158 becomes fully extended from cylinder 160 within actuator 150. Rocker linkage 170 comprises a first end 172 pivotally secured to distal end 156 of piston 158 and a second end 174 of rocker linkage 170 is pivotally secured to a first end 177 of a secondary linkage bar 176. A center of the rocker linkage 170 is pivotally secured to extension arm 122 at extension arm pivot 178.

As illustrated in exemplary FIG. 2, rocker linkage 170 can be configured in a diamond-like shape having one or more generally triangular cutouts 188 formed within linkage 170. Cutouts 188 are configured to reduce the overall weight of shear device 100. Because shear 100 may be used on small equipment, weight reduction using cutouts 188 may be desirable. However, in another exemplary embodiment (not depicted), shear device 100 may be configured without any cutouts 188 to facilitate maximizing the strength of linkage 170.

Secondary linkage bar 176 comprises a material that is the same as or similar to that of mounting plates 115, 117. Secondary linkage bar 176 is configured to pivotally secure a portion of second cutting member 127 to a distal end 180 of secondary linkage bar 176. Secondary linkage bar 176 is further configured to transfer force from the extension of piston 158 and the pivoting of rocker linkage 170 to second cutting member 127. The shape of rocker linkage 170 and/or secondary linkage bar 176 can be optimized to handle the internal stresses in each member.

The pivotal attachments at first and second ends 172, 174 of rocker linkage 170, extension arm pivot 178 and distal end 180 of secondary linkage bar 176 are configured in a manner similar to that of pivot point 140, described herein. That is, these pivotal attachments can comprise any type of pivoting joint known in the art, such as, for example, a high strength sleeve and shaft assembly coupled to the rearward end potions of first linkage end 172 and distal end 156 of piston 158; second linkage end 174 and first secondary linkage bar end 177; and secondary linkage bar distal end 180 of second cutting member 127.

In one exemplary embodiment in accordance with the present invention, hydraulic actuator 150 uses rocker linkage 170 to create a force in the cutting blade of the shear that increases as the cutting blade nears its finished position (for example, nearing a closed position as illustrated in FIG. 5), or as piston 158 becomes fully extended from cylinder 160. That is, as piston 158 extends from cylinder 160, extension arm 122 remains substantially fixed. Meanwhile, rocker linkage 170 is pivotally coupled to both extension arm 122 and piston 158 and rocker linkage 170 is further pivotally connected to first secondary linkage bar end 177. As piston 158 extends outward, rocker linkage 170 rotates about extension arm pivot 178 and transfers force from extending piston 158 to force on secondary linkage bar 176, thereby facilitating closure of second cutting member 127 onto first cutting member 120. Thus, there is a transfer of energy from the extension of piston 158 to the closing of second cutting member 127.

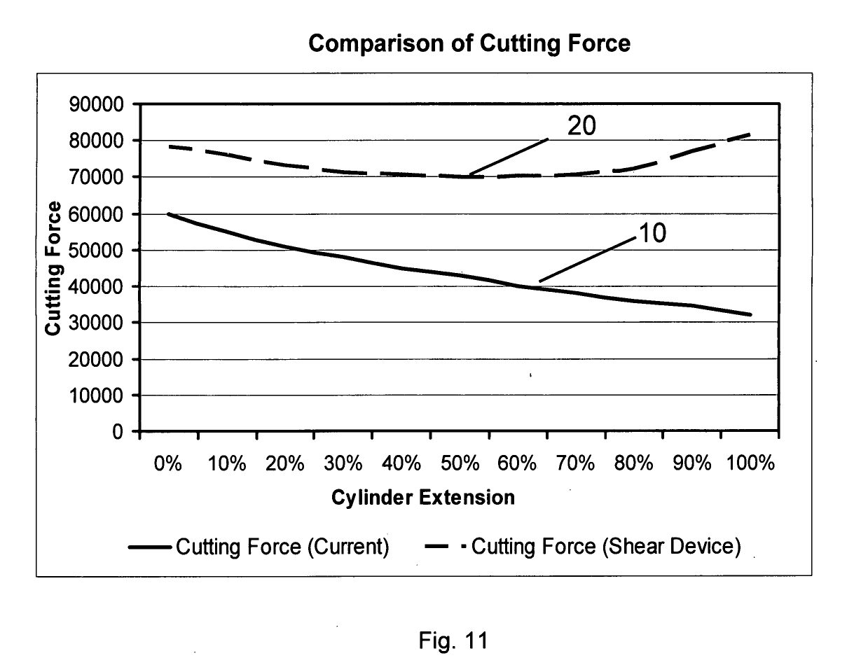

Referring now to FIG. 11, a line graph illustrating the cutting force of a prior art tree shear 10 and a line graph depicting the cutting force of a tree shear 20 made in accordance to one of the embodiments herein is provided. As depicted in the graph, the cutting force of prior art tree shear 10 decreases as the hydraulic actuator becomes more fully extended. However, tree shear 20 made in accordance to one or more of the embodiments presented herein shows that while there is a slight dip in the cutting force, the cutting force will increase as the hydraulic actuator moves towards a full extension. This increase in cutting force is a result of the force transfer from piston 158 extension to rocker linkage 170 to secondary linkage bar 176 to second cutting member 127. The increase in cutting force is also related to the positioning of pivotal attachments at first and second ends 172, 174 of rocker linkage 170, extension arm pivot 178 and distal end 180 of secondary linkage bar 176. For example, pivotal attachments at first and second ends 172, 174 of rocker linkage 170, extension arm pivot 178 and distal end 180 of secondary linkage bar 176 can be disposed at any location along linkage 170 to vary the amount of force exerted by shear device 100. In one exemplary embodiment, when pivot 178 is disposed at a generally central location within linkage 170, shear device 100 provides a generally flat force curve as it is operated with a rise in force as blade 125 nears being completely closed.

In another embodiment in accordance with the present invention, shear device 100 comprises a coupler plate 110 configured to facilitate mounting shear device 100 to a vehicle described herein (not shown). In one exemplary embodiment, shear device 100 is coupled to coupler plate 110 to facilitate selective pivoting shear device 100 about a rotational axis that extends generally perpendicularly from coupler plate 110. In another exemplary embodiment, coupler plate 110 is comprised of a universal two-pin, quick-attach hitch to couple shear device 100 to different vehicles. However, it is contemplated that other mounting assemblies could be used to secure shear device 100 to a vehicle. In addition, one or more actuators may be configured on the vehicle to facilitate moving coupler plate 110 up and down with respect to the operating surface. In one exemplary embodiment, coupler plate 110 is configured to facilitate rotation of tree shear 100 from a horizontal to a vertical position (as well as any number of positions in between). Coupler plate is also configured to protect hydraulic actuator 150 from debris.

One or more components of the shear device 100, such as mounting plates 115, 117 and second cutting member 127 can be manufactured from numerous materials that are durable and have sufficient strength for the contemplated uses. One preferred embodiment of the shear device 100 is constructed from high-strength steel, such as ASTM-A-572 Grade 50 High Tensile Plate, or its approximate equivalent. The plate steel provides benefits beyond that of strength. The plate steel provides ease of manufacture. Mounting plates 115, 117, second cutting member 127, mounting brackets and bracing members can all be cut from a single plate of steel, without the need of further processing and manufacture. Accordingly, the total cost of manufacture can be decreased. Moreover, the plate steel permits cutting edge 125 of second cutting member 127 to be easily formed through flame cutting or similar process and then ground to provide an optimum cutting edge. In the event the cutting edge is blemished during future use, it can be easily sharpened on location with a simple hand grinder.

In operation, the shear device 100 of the present invention can be used to cut irregularly shaped objects comprised of a wide range of materials. In one exemplary embodiment, shear device 100 is well suited for felling, sizing and pruning trees and brush. For example, the operator can position shear device 100 closely adjacent a limb of a tree at nearly any angle and at various heights above ground. First cutting member 120, second cutting member 127, and the gripping teeth substantially can help prevent shear device 100 and the vehicle the device is coupled to from being pushed away from the tree as the limb is severed by cutting edge 125. Accordingly, the available power of the system is directed at cutting and not wasted on maintaining the position of the shear device 100 and the vehicle with respect to the tree. This can be particularly helpful when the ground is wet, muddy or icy.

In another exemplary embodiment, a single-blade 125 shear device 100 can be used. The single-blade 125 shear device comprises a blade 125 that is configured to be secured into blade region 127. In another exemplary embodiment, a two-blade shear is provided that comprises a first blade secured into blade region 127 and a second blade secured into jaw region 120.

The present invention has been described above with reference to various exemplary embodiments. However, those skilled in the art will recognize that changes or modifications may be made to the exemplary embodiments without departing from the scope of the present invention. As used herein, the terms “comprises,” “comprising,” and/or any other variation thereof, are intended to cover a non-exclusive inclusion, such that a process, method, article, and/or apparatus that comprises a list of elements does not include only those elements but may include other elements not expressly listed and/or inherent to such process, method, article, and/or apparatus. Further, no element described herein is required for the practice of the invention unless expressly described as “essential” and/or “critical.”

What is claimed is:

1. A shear device, comprising:
a first and a second mounting plate forming a first cutting member having forward and rearward end portions and an upper edge portion;
a second cutting member having forward and rearward end portions, upper and lower side portions, and a cutting edge formed at least partially along the lower side portion, the rearward end portion of the first cutting member pivotally coupled to the rearward end portion of the second cutting member to facilitate moving the shear device between open and closed positions;
an extension arm extending from the first and second mounting plates;
a rocker linkage device with a first end, a second end and a center point;
an actuator having a cylinder with a first end coupled to the first cutting member and a piston slideably engaged in the cylinder having a distal end coupled to the first end of the rocker linkage device, the actuator configured to facilitate selectively moving the shear device between the open and closed positions as the piston extends outwardly from the cylinder;
a secondary linkage bar with a first end and a distal end, wherein the first end of the secondary linkage bar is pivotally connected to the second end of the rocker linkage device, and wherein the distal end of the secondary linkage bar is pivotally connected to the second cutting member;
wherein the rocker linkage device is configured to pivot at the center point about an end of the extension arm as the piston extends outwardly from the cylinder and is further configured to transfer force from the piston to the secondary linkage bar and wherein the secondary linkage bar is configured to further transfer force to the second cutting member

2. The device of claim 1, further comprising one or more teeth extending generally outwardly from the first cutting member, adjacent the upper edge portion, the teeth configured to engage an object disposed between the second cutting member and the first cutting member when the shear device is moved from the open to the closed positions.

3. The device of claim 1 wherein the first and second mounting plates are laterally spaced from one another to define an open pocket in the upper edge portion of the first cutting member, wherein the open pocket is shaped and sized to receive at least a portion of the cutting edge of the second cutting member when the shear device is in the closed position.

4. The device of claim 2 wherein the one or more teeth are configured to facilitate engaging an object disposed between the second cutting member and the first cutting member.

5. The device of claim 3 wherein the one or more teeth are further configured to substantially limit relative movement between the first cutting member and the object when the shear device is moved from the open position toward the closed position.

6. The device of claim 2, wherein the one or more teeth are shaped to have engagement points for at least partially piercing the object.

7. The device of claim 1, further comprising a coupler plate configured to couple the shear device with a vehicle.

8. The device of claim 7, wherein the shear device is coupled to the coupler plate to facilitate selective pivoting of the shear device about a rotational axis that extends generally perpendicularly from the coupler plate.

9. The device of claim 7, further comprising an actuator coupled to the shear device to selectively pivot the shear device about the rotational axis.

10. The device of claim 1 further comprising a fastener, which may be moved between tightened and loosened positions, the fastener transversely disposed through the first and second mounting plates in a manner that urges the first and second mounting plates toward one another when the fastener is tightened.

11. The device of claim 3, wherein the open pocket at least partially extends from the upper edge portion of the first cutting member through a lower edge portion of the first cutting member so that debris may be allowed to freely pass through the first cutting member.

12. The device of claim 10, wherein the fastener comprises a plurality of fasteners, which may be moved between tightened and loosened positions.

13. The device of claim 12, wherein the plurality of fasteners are positioned to substantially prevent the first and second mounting plates from moving away from one another when the shear is in use.

14. The device of claim 1 wherein the cutting edge of the second cutting member is removably coupled with the lower side portion of the second cutting member.

15. The device of claim 14, further comprising at least one fastener that removably secures the cutting edge to the lower side portion of the second cutting member.

16. The device of claim 1, wherein the rocker linkage device is configured in a substantially diamond shape.

17. The device of claim 1, wherein the secondary linkage bar is configured of a length less than a length of a fully extended piston.

18. The device of claim 1, further comprising a first blade disposed adjacent the upper edge portion of the first cutting member and protruding generally outwardly from the first cutting member, adjacent the upper edge portion, and a second blade disposed along the cutting edge of the second cutting member and protruding generally outwardly from the second cutting member, the first and second blades configured to engage an object disposed between the second cutting member and the first cutting member when the shear device is moved between the open and closed positions.

19. A vehicle configured for use with a shear device comprising:
a vehicle;
a shear device, comprising:
a first and a second mounting plate forming a first cutting member;
a second cutting member having forward and rearward end portions, upper and lower side portions, and a cutting edge formed at least partially along the lower side portion;
an extension arm extending from the first and second mounting plates;
a rocker linkage device with a first end, a second end and a center point;
an actuator having a cylinder with a first end coupled to the first cutting member and a piston slideably engaged in the cylinder having a distal end coupled to the first end of the rocker linkage device, the actuator configured to facilitate selectively moving the shear device between the open and closed positions as the piston extends outwardly from the cylinder;
a secondary linkage bar with a first end and a distal end, wherein the first end of the secondary linkage bar is pivotally connected to the second end of the rocker linkage device, and wherein the distal end of the secondary linkage bar is pivotally connected to the rearward end of the second cutting member;
wherein the rocker linkage device is configured to pivot at the center point about an end of the extension arm as the piston extends outwardly from the cylinder and is further configured to transfer force from the piston to the secondary linkage bar and wherein the secondary linkage bar is configured to further transfer force to the second cutting member; and
a coupler plate configured to couple the shear device with the vehicle.
